(19) United States
(12) Patent Application Publication
(10) Pub. No.: US 2026/0369183 A1
(43) Pub. Date: Nov. 19, 2026

(54) MOTION SYSTEM TO SIMULATE DYNAMIC PHYSIOLOGY

(71) Applicant: SIMULANDS AG, Zurich (CH)

(72) Inventors: Andrea GUIDOTTI, Zurich (CH); Pietro GOZZOLI, Zurich (CH); Luca VICENTINI, Opfikon (CH)

(73) Assignee: SIMULANDS AG, Zurich (CH)

(21) Appl. No.: 19/144,043

(22) PCT Filed: Dec. 27, 2023
(86) PCT No.: PCT/IB2023/063269

§ 371 Date: Jun. 27, 2025

Related U.S. Application Data
(60) Provisional application No. 63/436,260, filed on Dec. 30, 2022.

(51) Int. Cl. G09B 23/32; G09B 23/30

(52) U.S. Cl. CPC G09B 23/32; G09B 23/303

(57) ABSTRACT

A simulation system (10) is provided that includes a displaceable artificial anatomy (20); a fixed base (22); and one or 2024/141941 more base connectors (24), which couple the fixed base (22) to the artificial anatomy (20) at one or more respective base-attachment areas (34) of the artificial anatomy (20). One or more actuators (26) are connected to the artificial 5 anatomy (20) at respective actuator-connection locations (28) of the artificial anatomy (20), connect the artificial anatomy (20) to the fixed base (22), and are configured, upon actuation, to generate motion in the artificial anatomy (20). Other embodiments are also described.

### CROSS-REFERENCE TO RELATED APPLICATIONS

The present patent application claims priority from U.S. Provisional Application 63/436,260, filed Dec. 30, 2022, which is assigned to the assignee of the present application and incorporated herein by reference.

### FIELD OF THE INVENTION

The present disclosure relates generally to simulation systems for simulating anatomical structures for training and/or educational purposes.

### BACKGROUND OF THE INVENTION

One of the purposes of training for cardiac surgeons and for interventional cardiologists is to provide clinical personnel with a certain familiarity and acquaintance with the particular physiological conditions they will have to confront in the course of an intervention which involves the beating heart of a living patient.

U.S. Pat. No. 11,238,755 to Fiore et al. describes a test bench assembly for simulating cardiac surgery that includes a passive heart having at least one pair of cardiac chambers with an atrial chamber and a ventricular chamber. A reservoir is adapted to house working fluid. A pressure generator fluidically connects both to the ventricular chamber of the passive heart and to the reservoir. A pressure regulation device provides working fluid in input to the atrial chamber with preload pressure, and working fluid in output from the ventricular chamber with afterload pressure. The pressure regulation device fluidically connects both to the atrial chamber of the passive heart and to the ventricular chamber of the passive heart. The pressure regulation device has a single compliant element for each pair of cardiac chambers, which provides working fluid with both preload, and afterload pressures.

### SUMMARY OF THE APPLICATION

Some embodiments of the present invention provide a simulation system comprising a displaceable artificial anatomy, a fixed base, one or more base connectors, and one or more actuators (e.g., a plurality of actuators) connected between the artificial anatomy and the fixed base. The simulation system typically further comprises a controller, which comprises circuitry, which is configured in hardware and/or software to perform the control functions described herein. The one or more actuators are configured, upon actuation, to generate motion in the artificial anatomy.

The simulation system is configured to create a representative replica of the natural anatomy of reference, such as for training and educational purposes.

The artificial anatomy replicates a natural body anatomy, such as blood vessels, cardiac structures, vasculatures, or soft organs. For example, the natural body anatomy may include a portion of an aorta, such as an ascending aorta, aortic arch, and/or an upper portion of a descending aorta.

There is therefore provided, in accordance with an application of the present invention, a simulation system including:

a displaceable artificial anatomy; a fixed base; one or more base connectors, which couple the fixed base to the artificial anatomy at one or more respective base-attachment areas of the artificial anatomy; and one or more actuators, which are connected to the artificial anatomy at respective actuator-connection locations of the artificial anatomy, connect the artificial anatomy to the fixed base, and are configured, upon actuation, to generate motion in the artificial anatomy. For some applications, the one or more actuators include one or more linear actuators.

For some applications, the artificial anatomy is shaped as a blood vessel.

For some applications, the artificial anatomy is shaped as a portion of an aorta.

For some applications, the artificial anatomy is shaped as a cardiac structure.

For some applications, the simulation system includes exactly one actuator.

For some applications, the one or more actuators includes one or more respective motors, which are configured to generate the motion upon actuation of the one or more actuators.

For some applications, the apparatus further includes a controller, which is electrically coupled to the one or more actuators.

For some applications, the respective actuator-connection locations of the artificial anatomy are along respective connection sections of the artificial anatomy, and the controller is configured to drive the one or more actuators to generate the motion in the artificial anatomy so as to create a dynamic response of the artificial anatomy at the one or more respective connection sections of the artificial anatomy, and consequently an entirety of the artificial anatomy.

For some applications, the controller is configured to drive the one or more actuators to generate the motion in the artificial anatomy so as to cause one or more shape changes in the artificial anatomy.

For some applications, the one or more shape changes in the artificial anatomy are selected from the group consisting of: deflection of the artificial anatomy, deformation of the artificial anatomy, translation of the artificial anatomy, constriction of the artificial anatomy, elongation of the artificial anatomy, and shifting of the artificial anatomy.

For some applications, the simulation system is configured to simulate cardiac cycles, and the controller is configured to actuate the one or more actuators more than once per simulated cardiac cycle.

For some applications, the one or more actuators include two or more actuators, and the controller is configured to synchronize actuation of the two or more actuators.

For some applications, at least one of the one or more base-attachment areas of the artificial anatomy is near an end of the artificial anatomy.

For some applications, the at least one of the one or more base-attachment areas of the artificial anatomy is at the end of the artificial anatomy.

For some applications, the artificial anatomy comprises fixed and mobile portions, and at least one of the one or more base-attachment areas of the artificial anatomy is near an end of the mobile portion of the artificial anatomy. For some applications, the at least one of the one or more base-attachment areas of the artificial anatomy is at the end of the mobile portion of the artificial anatomy.

For some applications:
the one or more base-attachment areas of the artificial anatomy include first and second base-attachment areas of the artificial anatomy, and
the one or more base connectors include first and second base connectors, which couple the fixed base to the artificial anatomy at the first and the second base-attachment areas, respectively, of the artificial anatomy.

For some applications, the first and the second base-attachment areas of the artificial anatomy are near respective ends of the artificial anatomy.

For some applications, the first and the second base-attachment areas of the artificial anatomy are at the respective ends of the artificial anatomy.

For some applications, the artificial anatomy comprises fixed and mobile portions, and the first and the second base-attachment areas of the artificial anatomy are near respective ends of the mobile portion of the artificial anatomy. For some applications, the first and the second base-attachment areas of the artificial anatomy are at the respective ends of the mobile portion of the artificial anatomy.

For some applications, the actuator-connection locations of the artificial anatomy are longitudinally between the first and the second base-attachment areas of the artificial anatomy.

For some applications, the one or more actuators include exactly one actuator or exactly two actuators.

For some applications, the one or two actuators include linear actuators.

For some applications, the one or more actuators include two or more actuators.

For some applications, the simulation system includes exactly two actuators.

For some applications, the two or more actuators are placed in series along the same direction.

For some applications, the two or more actuators are placed in parallel along the same direction.

For some applications, the two or more actuators are placed alternated along the same direction.

The present invention will be more fully understood from the following detailed description of embodiments thereof, taken together with the drawings, in which:

### BRIEF DESCRIPTION OF THE DRAWINGS

FIGS. 1A and 1B are schematic illustration of a simulation system, in accordance with an application of the present invention;

FIG. 1C is a schematic illustration of a portion of the simulation system of FIGS. 1A and 1B, in accordance with an application of the present invention;

FIG. 2 is a schematic illustration of an actuator of the simulation system of FIGS. 1A-C, in accordance with an application of the present invention;

FIGS. 3A-C are schematic illustrations of respective configurations of artificial anatomy connectors of the simulation system of FIGS. 1A-C, in accordance with respective applications of the present invention;

FIGS. 4A and 4B are schematic illustrations of respective configurations of artificial anatomy of the simulation system of FIGS. 1A-C, in accordance with respective applications of the present invention;

FIGS. 5A-B are schematic illustrations of exemplary displacement of artificial anatomy of the simulation system of FIGS. 1A-C, in accordance with an application of the present invention;

FIG. 6 is a schematic representation of the cardiac cycle from an electrocardiographic point-of-view (ECG), its related cyclic heart displacement, and a schematic representation of the displacement due to the breathing cycle, which is not fully synchronized with the cardiac cycle;

FIG. 7 is a flowchart that schematically illustrates a method for use with the simulation system of FIGS. 1A-C, in accordance with an application of the present invention; and

FIGS. 8A-E are photographs and drawings illustrating some of the steps of the method of FIG. 7, in accordance with respective applications of the present invention.

### DETAILED DESCRIPTION OF EMBODIMENTS

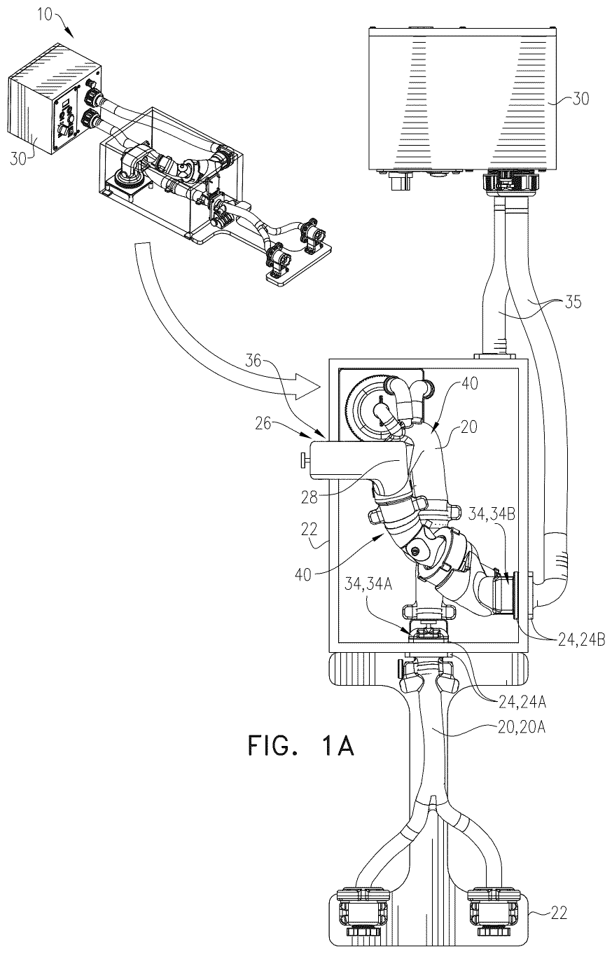

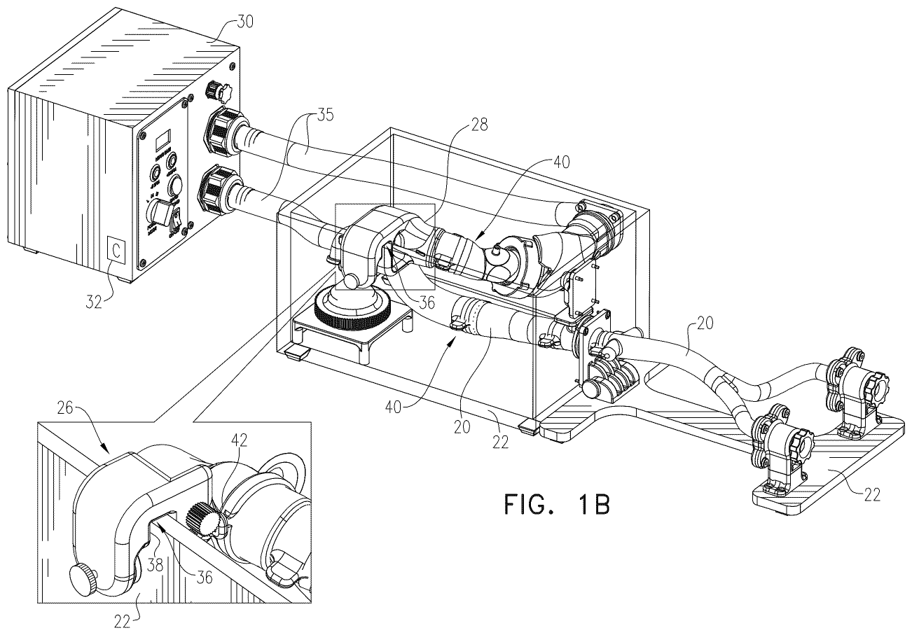

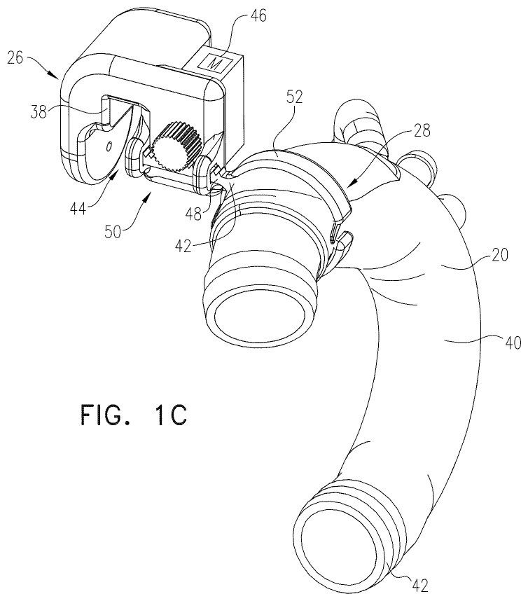

FIGS. 1A and 1B are schematic illustration of a simulation system 10, in accordance with an application of the present invention. FIG. 1C is a schematic illustration of a portion of simulation system 10, in accordance with an application of the present invention. Simulation system 10 comprises a displaceable artificial anatomy 20, a fixed base 22, one or more base connectors 24, and one or more actuators 26 (e.g., a plurality of actuators 26). The one or more actuators 26 are connected to artificial anatomy 20 at respective actuator-connection locations 28 of artificial anatomy 20 (one actuator-connection location 28 is labeled in FIG. 1C), and connect artificial anatomy 20 to fixed base 22. The one or more actuators 26 are configured, upon actuation, to generate motion in artificial anatomy 20 (typically with respect to fixed base 22).

Simulation system 10 typically further comprises a controller 30, which comprises circuitry 32 (shown schematically in FIG. 1B), which is configured in hardware and/or software to perform the control functions described herein (for example, controller 30 may comprise one or more processors and memory). Controller 30 is electrically coupled to the one or more actuators 26.

Simulation system 10 is configured to create a representative replica of the natural anatomy of reference, such as for training and educational purposes. Artificial anatomy 20 replicates a natural body anatomy, such as blood vessels, cardiac structures, vasculatures, or soft organs. For example, the natural body anatomy may include a portion of an aorta, such as an ascending aorta, aortic arch, and/or an upper portion of a descending aorta.

Fixed base 22 acts as inertial element of the assembly, and supports both artificial anatomy 20 and the one or more actuators 26.

Fixed base 22 is solid in structure, non-deformable, with a weight to support and keep in position the entire assembly, even when artificial anatomy 20 and the one or more actuators 26 are subject to dynamic movements during ordinary operation.

As described above, the one or more base connectors 24 couple fixed base 22 to artificial anatomy 20 at one or more respective base-attachment areas 34 of artificial anatomy 20 (e.g., bonded/constrained/attached). Typically, the one or more base connectors 24 fixedly couple the fixed base 22 to artificial anatomy 20 at the one or more respective base-attachment areas 34, such that the one or more base-attachment areas 34 are immobilized with respect to fixed base 22.

Tubing 35 outside fixed base 22 is not part of artificial anatomy 20. In the configuration shown by way of example in FIGS. 1A-C, a portion 20A of artificial anatomy 20 simulates the femoral and abdominal arteries. As they are positioned in the abdominal and hip region, their displacement can be considered negligible, so that this portion 20A of artificial anatomy 20 can be considered as a fixed structure.

For some applications, at least one of the one or more base-attachment areas 34 of artificial anatomy 20 is near (e.g., at) an end of artificial anatomy 20, or near an end of a mobile portion of artificial anatomy 20 (i.e., excluding any fixed portions of the artificial anatomy, such as portion 20A described above), such as shown.

For some applications, the one or more base-attachment areas 34 of artificial anatomy 20 include first and second base-attachment areas 34A and 34B of artificial anatomy 20, and the one or more base connectors 24 comprise first and second base connectors 24A and 24B, which couple fixed base 22 to artificial anatomy 20 at first and second base-attachment areas 34A and 34B, respectively, of artificial anatomy 20. For some of these applications, first and second base-attachment areas 34A and 34B of artificial anatomy 20 are near (e.g., at) respective ends of artificial anatomy 20, or near respective ends of a mobile portion of artificial anatomy 20.

Artificial anatomy 20 may be constructed of soft material or combination of soft and rigid material, such as silicone, plastic, polyurethane, synthetic polymer, and/or tissue. Artificial anatomy 20 is able to move within certain ranges when constrained to fixed base 22 and subject to internal force, including flow of liquid pumped within its structures, or external, including when an actuator 26 is applying a vector of force to artificial anatomy 20.

Fixed base 22 remains static, and artificial anatomy 20 may be static or subject to an internal force (e.g., from a liquid flowing through artificial anatomy 20). The one or more actuators 26 are coupled to respective specific stationary base-connection locations 36 on fixed base 22 on one end 38 of each actuator 26 and to respective actuator-connection locations 28 along respective connection sections 40 of artificial anatomy 20 on the other end 42 of the actuator 26, such that respective actuator-connection locations 28 of specific sections 40 of artificial anatomy 20 are moveable with respect to fixed base 22 upon actuation of the one or more actuators 26, respectively.

For some applications, actuator-connection locations 28 of artificial anatomy 20 are longitudinally between first and second base-attachment areas 34A and 34B of artificial anatomy 20 (which optionally are near (e.g., at) respective ends of artificial anatomy 20). The phrase “longitudinally between” means longitudinally between along artificial anatomy 20 (rather than falling on a straight line between first and second base-attachment areas 34A and 34B).

Each of the one or more actuators 26 typically comprises (labeled in FIG. 1C):
an attachment mechanism 44 configured to couple the actuator 26 to fixed base 22;
a motor 46 joined to attachment mechanism 44; and
an actuator arm 48 which comprises a joint element 50 on one end of the actuator arm 48, and an artificial anatomy connector 52 on the other end of the actuator arm 48.

Joint element 50 is coupled to motor 46. Artificial anatomy connector 52 is coupled to one of actuator-connection locations 28 along one of connection sections 40 of artificial anatomy 20.

Actuator motor 46 is configured to create a rotational, linear or variable motion, which is translated to the actuator arm 48.

Actuator arm 48 comprises a rigid material, so to translate the motion created by the motor 46 across actuator arm 48.

For some applications, each of actuator arms 48 is shaped so as to connect the actuator to artificial anatomy 20 and to connect to artificial anatomy 20 in a pre-defined position and direction.

For some applications, actuator 26 is configured to translate the generated motion to artificial anatomy 20 and so to create a dynamic response of artificial anatomy 20 at the specific connection section 40 or sections, and consequently an entirety of artificial anatomy 20.

For some applications, artificial anatomy 20 is configured, when connected to fixed base 22 and subject to the actuator motion, to be deflected, deformed, translated, constricted, elongated, and/or shifted.

For some applications, the one or more actuators 26 are designed, sized, powered and/or positioned in specific areas of fixed base 22 and of artificial anatomy 20 so to create a dynamic motion of artificial anatomy 20 that replicates physiological motion of the natural anatomy in a living being, as derived from literature data or diagnostic data, such as using computer tomography imaging, magnetic resonance imaging, fluoroscopy x-ray imaging and/or ultrasound imaging.

In some applications, system 10 comprises exactly one actuator 26.

For other applications, system 10 comprises two or more actuators 26, such as exactly two actuators 26, three or four actuators 26, or five or more actuators 26.

For some applications, simulation system 10 (e.g., controller 30 thereof) is configured to simulate cardiac cycles. For some of these applications, one actuator 26 or all actuators 26 are configured to be actuated more than once per simulated cardiac cycle (e.g., synchronized to the simulated cardiac cycle, or with a simulated ECG, or more than 3 actions of the actuator per simulated cardiac cycle).

For some applications in which system 10 comprises a plurality of actuators 26, controller 30 is configured to synchronize actuation of the two or more actuators 26, for example by synchronizing the respective actuator motors 46, such as in series, in parallel, or as a combination of in parallel and in series.

For some applications in which system 10 comprises two actuators 26, the two actuators 26 are placed in series along the same direction of force. For example, if the direction of force is from North to South, the two actuators 26 can be positioned oriented parallel to this axis, in different areas of fixed base 22, connected to different base-attachment areas 34 of artificial anatomy 20. This arrangement may guarantee that the direction of the displacement is properly transmitted to the entire artificial anatomy 20.

For other applications in which system 10 comprises two actuators 26, the two actuators 26 are placed in parallel along the same direction of force. For example, if the direction of force is from North to South, the two actuators 26 can be positioned one near the other, on juxtaposed sites of fixed base 22, connected to nearby sections of artificial anatomy 20. This arrangement may apply different deformation waves to artificial anatomy 20 along the same direction of displacement.

For still other applications in which system 10 comprises two actuators 26, the two actuators 26 are placed alternated along the same direction of force, such that the displacements generated by the two actuators 26 have parallel directions, i.e., the two actuators 26 apply respective displacements to artificial anatomy 20 along respective axes that are parallel with each other, but with a distance between the two axes.

Reference is now made to FIG. 2, which is a schematic illustration of one of actuators 26, in accordance with an application of the present invention. For some applications, the one or more actuators 26 comprise linear actuators. For some applications, actuators 26 are configured to generate linear motion and translate the motion linearly to artificial anatomy Alternatively or additionally, the one or more actuators 26 may comprise rotational actuators (configuration not shown).

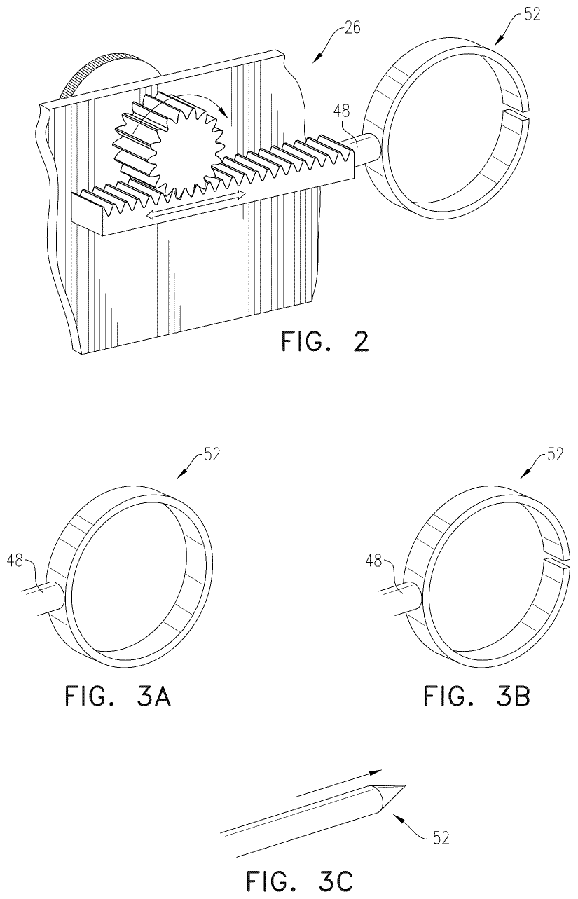

Reference is now made to FIGS. 3A-C, which are schematic illustrations of respective configurations of artificial anatomy connectors 52, in accordance with respective applications of the present invention. For some applications, at least one (e.g., all) of the artificial anatomy connectors 52 is fixed to artificial anatomy 20 at actuator-connection locations 28 along the respective connection section 40. For example, for these applications, artificial anatomy connectors 52 may be full connectors, as shown in FIG. 2A (as well as in FIGS. 1A-B).

For other applications, at least one (e.g., all) of artificial anatomy connectors 52 is positioned so to be in connection with artificial anatomy 20 during a specific time point of the dynamic motion. For example, actuator 26 may be configured to cause a displacement of artificial anatomy 20 during only a portion of the simulated cardiac cycle, and artificial anatomy 20 is in contact with artificial anatomy connector 52 at only a certain phase of the displacement, but not during the entire displacement of actuator arm 48.

For still other applications, at least one (e.g., all) of artificial anatomy connectors 52 is coupled with artificial anatomy 20 so as to allow some motion between artificial anatomy 20 and artificial anatomy connector 52. For example, artificial anatomy connector 52 may be configured to allow artificial anatomy 20 to react to the deformation caused by the actuator-induced movement of artificial anatomy 20, such as by moving within artificial anatomy connector 52 or from artificial anatomy connector 52 along the dynamic movement created by artificial anatomy connector 52. For example, artificial anatomy connector 52 may be coupled to artificial anatomy 20 so as to allow artificial anatomy 20 to move from the actuation point when subject to the actuation (e.g., to allow artificial anatomy 20 to slide within artificial anatomy connector 52. For example, for these applications, artificial anatomy connectors 52 may have the shape of a C-connector, such as shown in FIG. 3B (as well as in FIGS. 1C and 2). Alternatively, for example, for these applications, artificial anatomy connectors 52 may have the shape of a spike connector, intended to puncture and be coupled to the artificial anatomy 2, such as shown in FIG. 3C. For some applications, whether artificial anatomy connectors 52 are fixedly or movingly coupled to artificial anatomy 20, at least one of artificial anatomy connectors 52 is jointedly coupled its respective actuator arm 48, by a respective joint.

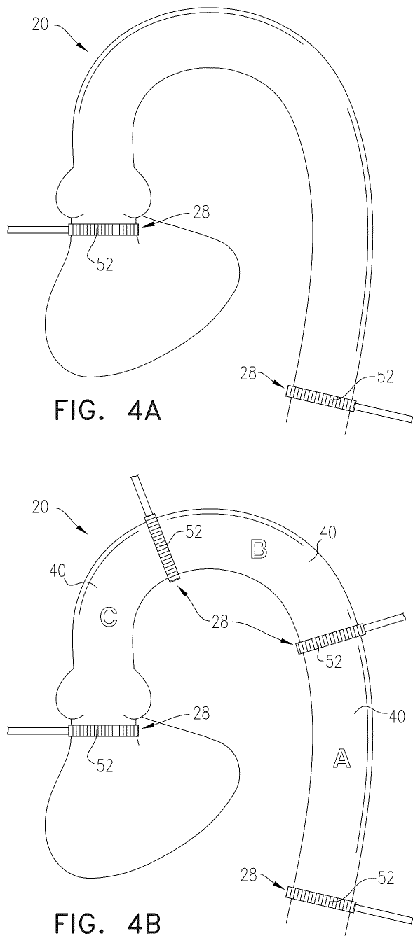

Reference is now made to FIGS. 4A and 4B, which are schematic illustrations of respective configurations of artificial anatomy 20, in accordance with respective applications of the present invention. For some applications, all or a portion of artificial anatomy 20 has uniform characteristics, such as shown in FIG. 4A. For other applications, artificial anatomy 20 comprises sections having respective different characteristics, such as shown in FIG. 4B. The respective actuator-connection locations 28 may be disposed along respective connection sections 40 of artificial anatomy 20 having these different characteristics. Differences in the material properties (e.g. stiffness, elasticity), as well as the ability to deform more or less along the longitudinal axis and/or radially, may be specific for each segment.

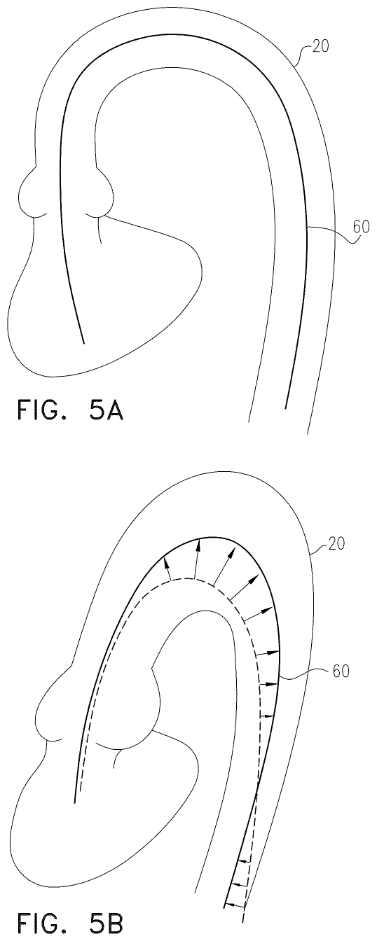

Reference is now made to FIGS. 5A-B, which are schematic illustrations of exemplary displacement of artificial anatomy 20, in accordance with an application of the present invention. System 10 is typically configured to dynamically modify the disposition of artificial anatomy 20, for example such that movement of a center line 60 of artificial anatomy 20 (e.g., in applications in which artificial anatomy 20 comprises an artificial blood vessel) reflects the dynamic movement as observed in corresponding natural anatomy in living beings.

Simulator system 10 is typically configured to create a realistic representation of the natural or pathological anatomy, whichever may be relevant for the training or educational purposes, in the sense of anatomical interaction and vessel dynamics, as compared to the same assembly without the actuator system.

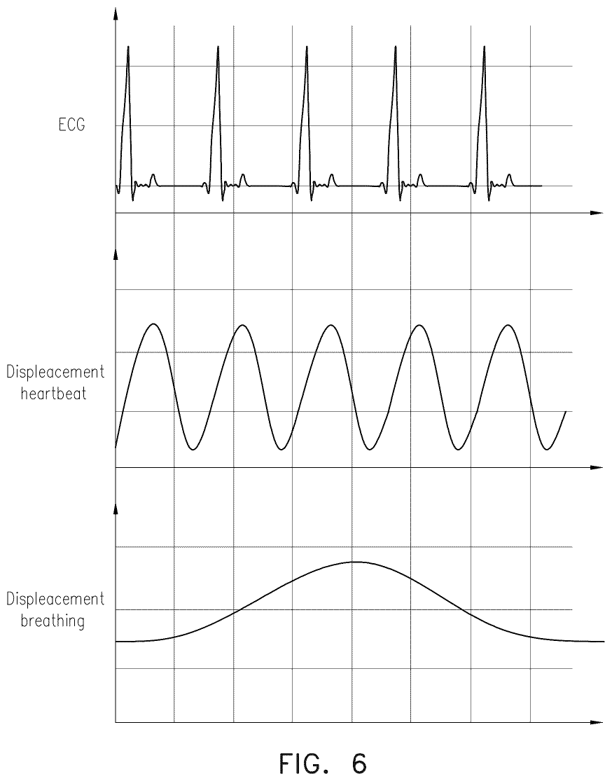

Reference is now made to FIG. 6, which is a schematic representation of the cardiac cycle from an electrocardiographic point-of-view (ECG) (top graph) and its synchronized displacement (central graph). During the systolic-diastolic cycle, the displacement of the heart structure follows the same pattern at the same interval as the electrocardiographic cycle. Additional displacement may be generated by the respiratory cycle (bottom graph), which is not fully synchronized to the heartbeat, and which is typically 3 to 8 times slower than the cardiac cycle.

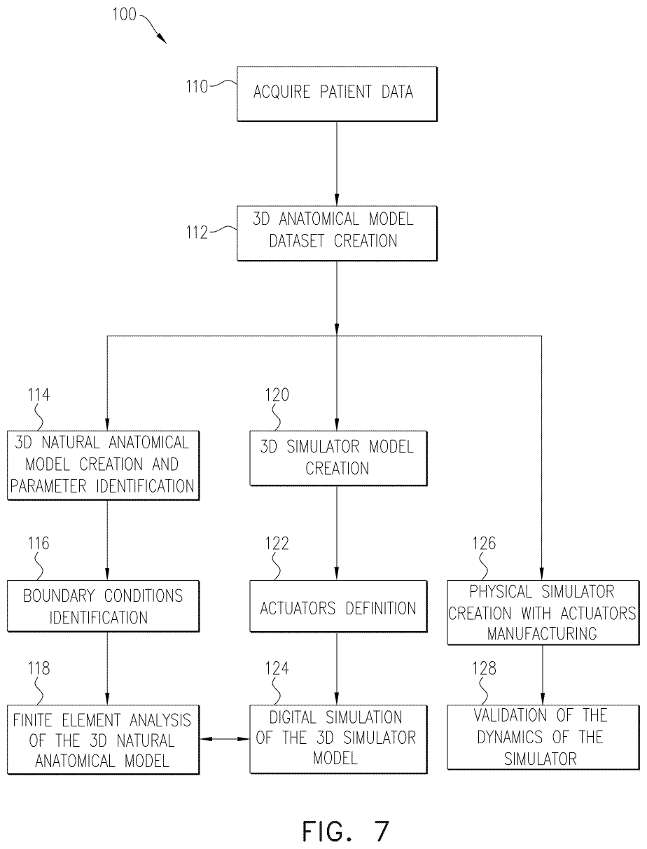

Reference is now made to FIG. 7, which is a flowchart that schematically illustrates a method 100 for use with simulation system 10, in accordance with an application of the present invention. Reference is also made to Figs. SA-E, which are photographs and drawings illustrating some of the steps of method 100, in accordance with respective applications of the present invention. In some applications of the present invention, system 10 is planned, designed, configured, manufactured, assembled, utilized, tested, and/or validated using one or more of the following steps:

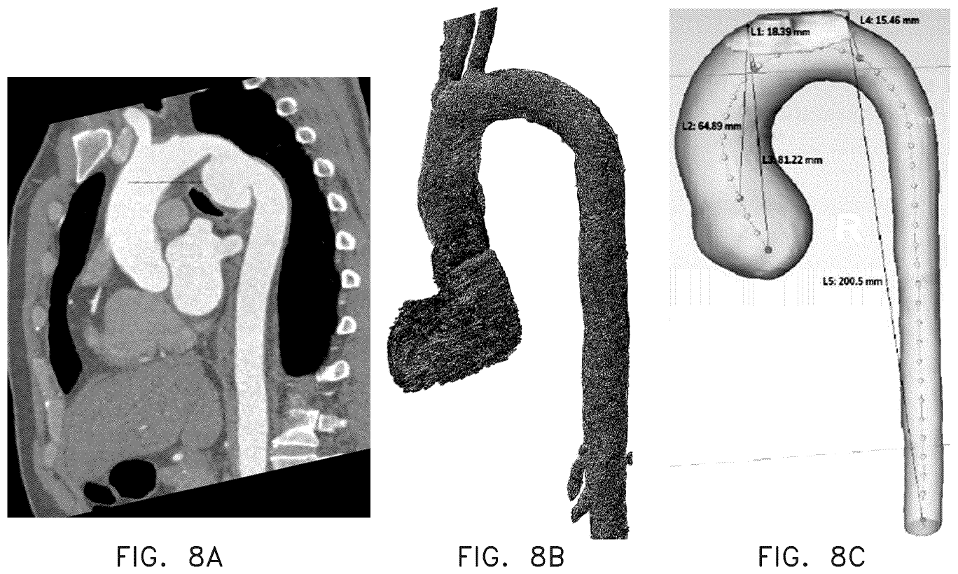

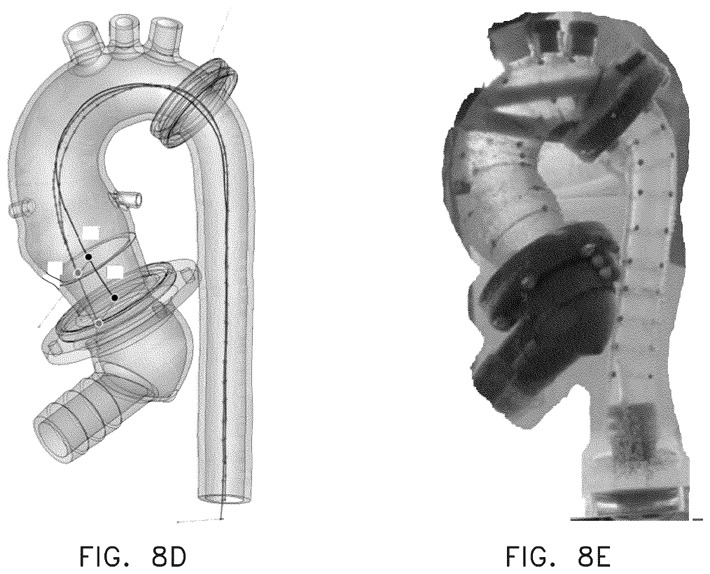

At a data acquisition step 110, patient data of the target natural anatomy is acquired during a full cardiac cycle from patient diagnostic imaging, such as computer tomography scan imaging, magnetic resonance imaging, echographic ultrasound 2D and 3D imaging, and/or fluoroscopic x-ray imaging. The diagnostic imaging typically represent at least one phase of the cardiac cycle, an interval of the cardiac cycle, or samples of the cardiac cycle (e.g., every 10% of the RR interval between two R waves), or a full cardiac cycle. FIG. 8A shows one exemplary set of images of the acquired natural anatomy.

At a 3D model dataset creation step 112, a 3D model dataset is created by extraction from diagnostic patient data, which may be classified, labeled, and segmented, including volumetric, spatial and surface data. FIG. 8B shows one exemplary schematic illustration of a 3D model dataset.

At a 3D natural anatomical model creation step 114, a 3D natural anatomical model is created by identifying parameters of the 3D model dataset for finite element analysis, such as vessel center line, vessels and chambers eccentricity, and/or anatomy displacement during the cardiac cycle.

At a boundary conditions identification step 116, boundary conditions of the target reconstructed anatomy are identified, including wall behaviors and characteristics, and/or model flow working condition and internal pressure.

At a finite element analysis step 118, finite element analysis (FEA) of the target natural anatomy reconstructed model is performed, modelling the physiological movements along the full cardiac cycle. FIG. 8C shows the generation of the first 3D data model as described at natural anatomical model creation step 114. The model allows the identification of the relevant parameters to be included for the next steps. For example, when displacements below a predefined value are observed, such changes in the position should not be included in the following steps. Additionally, FIG. 8C shows the identification of the individual segments, as described in FIG. 4B, by observing specific changes in the vector of displacements. Boundary conditions are defined by observing the maximal and minimal displacement for each segment, as described at boundary conditions identification step 116.

At a 3D simulator model creation step 120, a 3D simulator model of the target natural anatomy is created from the dataset extracted at 3D natural anatomical model creation step 114.

At an actuators identification step 122, base-connection locations 36 on fixed base 22 and actuator-connection locations 28 on artificial anatomy 20 are defined and identified, in order to identify whether one or more linear actuators are required in order to create a motion of the target anatomical structures which would resemble the motion of the natural patient anatomy during the full cardiac cycle. More generally, by knowing the boundary conditions, actuator-connection locations 28 and their displacement are defined.

At a digital simulation step 124, actuators 26 and the 3D simulator model are implemented in the finite element model by setting additional boundary and vector elements, and comparing the 3D simulator model created at 3D simulator model creation step 120 with the 3D natural anatomical model created at 3D natural anatomical model creation step 114; for example, the comparing may be performed using finite element analysis. Differences in system behaviors may be analyzed to verify that such displacement generated by one or more linear actuators are able to approximate the target physiological motion as evidenced in the 3D natural anatomical model. FIG. 8D shows the generation of a 3D simulator model suitable for the creation of a physical prototype, such as described at 3D simulator model creation step 120.

At a design and manufacturing step 126, a physical mock-up and actuators 26 and control parameters (including of displacement) is designed and manufactured, including calibration of actuators 26 for the linear displacement scale and direction (vector) to recreate physiological motion, including displacement, deformation, expansion and compression.

At a validation step 128, the physical model is validated, including its response to actions of the actuators 26, by measuring the dynamic behaviors of the simulator artificial anatomy against the data collected from the patients at data acquisition step 110 and extracted at 3D model dataset creation step 112, e.g., the center line displacement across the cardiac cycle in the 3D natural anatomical model created at 3D natural anatomical model creation step 114 and the physical model created at design and manufacturing step 126. Validation step 128 typically includes validation that actuators 26 are correctly calibrated and correctly positioned with respect to artificial anatomy 20 and fixed base 22. FIG. 8E shows one exemplary simulation system 10 manufactured and validated as described with reference to steps 126 and 128, respectively.

In an embodiment, techniques and apparatus described in U.S. Provisional Application 63/436,260, filed Dec. 30, 2022, which is assigned to the assignee of the present application and incorporated herein by reference, are combined with techniques and apparatus described herein.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A simulation system comprising:
a displaceable artificial anatomy;
a fixed base;
one or more base connectors, which couple the fixed base to the artificial anatomy at one or more respective base-attachment areas of the artificial anatomy; and
one or more actuators, which are connected to the artificial anatomy at respective actuator-connection locations of the artificial anatomy, connect the artificial anatomy to the fixed base, and are configured, upon actuation, to generate motion in the artificial anatomy.

2. The simulation system according to claim 1, wherein the one or more actuators comprise one or more linear actuators.

3. The simulation system according to claim 1, wherein the artificial anatomy is shaped as a blood vessel.

4. The simulation system according to claim 3, wherein the artificial anatomy is shaped as a portion of an aorta.

5. The simulation system according to claim 1, wherein the artificial anatomy is shaped as a cardiac structure.

6. The simulation system according to claim 1, wherein the simulation system comprises exactly one actuator.

7. The simulation system according to any one of claims 1-6, wherein the one or more actuators comprises one or more respective motors, which are configured to generate the motion upon actuation of the one or more actuators.

8. The simulation system according to any one of claims 1-6, further comprising a controller, which is electrically coupled to the one or more actuators.

9. The simulation system according to claim 8, wherein the respective actuator-connection locations of the artificial anatomy are along respective connection sections of the artificial anatomy, and wherein the controller is configured to drive the one or more actuators to generate the motion in the artificial anatomy so as to create a dynamic response of the artificial anatomy at the one or more respective connection sections of the artificial anatomy, and consequently an entirety of the artificial anatomy.

10. The simulation system according to claim 8, wherein the controller is configured to drive the one or more actuators to generate the motion in the artificial anatomy so as to cause one or more shape changes in the artificial anatomy.

11. The simulation system according to claim 10, wherein the one or more shape changes in the artificial anatomy are selected from the group consisting of: deflection of the artificial anatomy, deformation of the artificial anatomy, translation of the artificial anatomy, constriction of the artificial anatomy, elongation of the artificial anatomy, and shifting of the artificial anatomy.

12. The simulation system according to claim 8, wherein the simulation system is configured to simulate cardiac cycles, and wherein the controller is configured to actuate the one or more actuators more than once per simulated cardiac cycle.

13. The simulation system according to claim 8, wherein the one or more actuators comprise two or more actuators, and wherein the controller is configured to synchronize actuation of the two or more actuators.

14. The simulation system according to any one of claims 1-6, wherein at least one of the one or more base-attachment areas of the artificial anatomy is near an end of the artificial anatomy.

15. The simulation system according to claim 14, wherein the at least one of the one or more base-attachment areas of the artificial anatomy is at the end of the artificial anatomy.

16. The simulation system according to any one of claims 1-6, wherein the artificial anatomy comprises fixed and mobile portions, and wherein at least one of the one or more base-attachment areas of the artificial anatomy is near an end of the mobile portion of the artificial anatomy.

17. The simulation system according to claim 16, wherein the at least one of the one or more base-attachment areas of the artificial anatomy is at the end of the mobile portion of the artificial anatomy.

18. The simulation system according to any one of claims 1-6,
wherein the one or more base-attachment areas of the artificial anatomy include first and second base-attachment areas of the artificial anatomy, and
wherein the one or more base connectors comprise first and second base connectors, which couple the fixed base to the artificial anatomy at the first and the second base-attachment areas, respectively, of the artificial anatomy.

19. The simulation system according to claim 18, wherein the first and the second base-attachment areas of the artificial anatomy are near respective ends of the artificial anatomy.

20. The simulation system according to claim 19, wherein the first and the second base-attachment areas of the artificial anatomy are at the respective ends of the artificial anatomy.

21. The simulation system according to claim 18, wherein the artificial anatomy comprises fixed and mobile portions, and wherein the first and the second base-attachment areas of the artificial anatomy are near respective ends of the mobile portion of the artificial anatomy.

22. The simulation system according to claim 21, wherein the first and the second base-attachment areas of the artificial anatomy are at the respective ends of the mobile portion of the artificial anatomy.

23. The simulation system according to claim 18, wherein the actuator-connection locations of the artificial anatomy are longitudinally between the first and the second base-attachment areas of the artificial anatomy.

24. The simulation system according to claim 23, wherein the one or more actuators comprise exactly one actuator or exactly two actuators.

25. The simulation system according to claim 23, wherein the one or two actuators comprise linear actuators.

26. The simulation system according to any one of claims 1-6, wherein the one or more actuators comprise two or more actuators.

27. The simulation system according to claim 26, wherein the simulation system comprises exactly two actuators.

28. The simulation system according to claim 26, wherein the two or more actuators are placed in series along the same direction.

29. The simulation system according to claim 26, wherein the two or more actuators are placed in parallel along the same direction.

30. The simulation system according to claim 26, wherein the two or more actuators are placed alternated along the same direction.
